(19) United States
(12) Patent Application Publication
(10) Pub. No.: US 2024/0190453 A1
(43) Pub. Date: Jun. 13, 2024

(54) VEHICULAR COMMUNICATION AND ALERT SYSTEM

(71) Applicant: Magna Electronics Inc., Auburn Hills, MI (US)

(72) Inventors: Jagadish Narayan Gowda, Bengaluru (IN); Prashanth Jay Kumar, Bengaluru (IN)

(21) Appl. No.: 18/524,290

(22) Filed: Nov. 30, 2023

Related U.S. Application Data
(60) Provisional application No. 63/386,344, filed on Dec. 7, 2022.

(51) Int. Cl. B60W 50/08; B60W 30/14; B60W 50/14; G06Q 40/08

(52) U.S. Cl. CPC B60W 50/085; B60W 30/146; B60W 50/14; G06Q 40/08; B60W 2050/146; B60W 2556/45

(57) ABSTRACT

A vehicular alert system includes an electronic control unit (ECU) disposed at a vehicle equipped with the vehicular alert system. The vehicular alert system is in wireless communication with a remote server that is remote from the vehicle. The vehicular alert system receives a first wireless communication from the remote server. The first wireless communication is pertaining to an insurance policy associated with the vehicle. The vehicular alert system, based on the first wireless communication, and responsive to determination that the insurance policy will expire in less than a threshold period of time, generates an alert for a driver of the vehicle.

### CROSS REFERENCE TO RELATED APPLICATION

The present application claims the filing benefits of U.S. provisional application Ser. No. 63/386,344, filed Dec. 7, 2022, which is hereby incorporated herein by reference in its entirety.

### FIELD OF THE INVENTION

The present invention relates generally to a vehicular alert system for a vehicle and, more particularly, to a vehicular alert system that alerts a driver based on status of an insurance policy associated with the vehicle.

### BACKGROUND OF THE INVENTION

It is known to provide an alert system at a vehicle that displays messages, illuminates icons, or plays audio tones to, for example, notify a driver of the vehicle of required vehicle maintenance or to prompt the driver to put on a seatbelt.

### SUMMARY OF THE INVENTION

A vehicular alert system includes an electronic control unit (ECU) that includes electronic circuitry and associated software. The electronic circuitry includes a wireless communication module, which may have a transmitting and/or receiving antenna. The wireless communication module is configured to wirelessly communicate with a remote server that is disposed remote from a vehicle equipped with the vehicular alert system. The system, via the wireless communication module, receives wireless communications from the remote server. The wireless communications are related to an insurance policy associated with the vehicle. The system, via processing of the wireless communications at the ECU, determines an expiration time of the insurance policy. The system, responsive to determination that the expiration time has not yet occurred and that the expiration time will occur in less than a threshold period of time, generates an alert for a driver of the vehicle to alert the driver of the impending expiration of the policy. Optionally, the system may limit or degrade vehicle functionalities (e.g., may limit acceleration or top speed) if the vehicle insurance policy expires, and may alert the driver of the degraded functionalities.

Optionally, the vehicle may be equipped with a vision system including one or more cameras or sensors disposed at the vehicle and the ECU may include an image processor or data processor configured to process sensor data captured by the one or more sensors. The system may communicate the captured sensor data, or driving information derived from the captured sensor data, to the remote server.

Optionally, the system may store insurance information related to the insurance policy in memory storage at the vehicle and the system may, upon receiving a request from a remote device, communicate requested insurance information to the remote device to fulfill the request.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle equipped with an alert system; and

FIG. 2 is a schematic view of the alert system.

### DESCRIPTION OF THE PREFERRED EMBODIMENTS

A vehicular communication and alert system and/or driver or driving assist system operates to wirelessly communicate with an external or remote server remote from a vehicle equipped with the communication and alert system. The system wirelessly communicates with the remote server to determine status of an insurance policy associated with the vehicle and/or share information related to operation of the vehicle. Optionally, the system may operate to capture images and/or sensor data exterior of the vehicle and may process the captured image data and sensor data to determine a driving condition of the vehicle, to store the captured image and/or sensor data, and/or to communicate the captured image and/or sensor data to the external server.

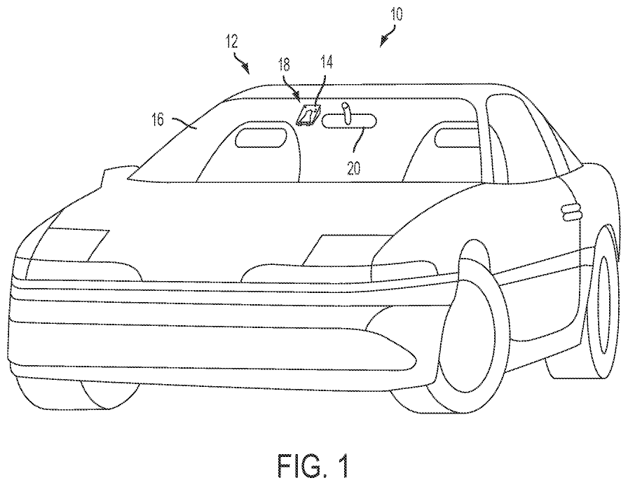

Referring now to the drawings and the illustrative embodiments depicted therein, a vehicle 10 equipped with the alert system 12 may include an electronics module 14 disposed at an inner portion of the vehicle, such as mounted to an interior surface of the vehicle like a headliner or in-cabin surface of a windshield 16 (FIG. 1). The electronics module 14 houses a control or electronic control unit (ECU) 18 having electronic circuitry and associated software. For example, the electronics module or the ECU 18 may include a wireless communication module (e.g., a transmitting and/or receiving antenna) so that the alert system 12 may wirelessly communicate with the remote server. As discussed further below, the vehicle 10 may be equipped with one or more sensors, such as one or more cameras disposed at the vehicle (e.g., a forward viewing camera disposed at the electronics module 14 and viewing through the windshield of the vehicle, or a driver monitoring camera viewing a head region of the driver of the vehicle, and/or a plurality of exterior cameras having a respective camera disposed at the front, rear and sides (such as at exterior rearview mirrors of the vehicle) and/or the like). The electronic circuitry may include a data processor or image processor that is operable to process image data captured by the camera or cameras, whereby the ECU may detect or determine presence of objects or the like and/or the system provide displayed images at a display device 20 for viewing by the driver of the vehicle (which may be part of or incorporated in or at an interior rearview mirror assembly of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

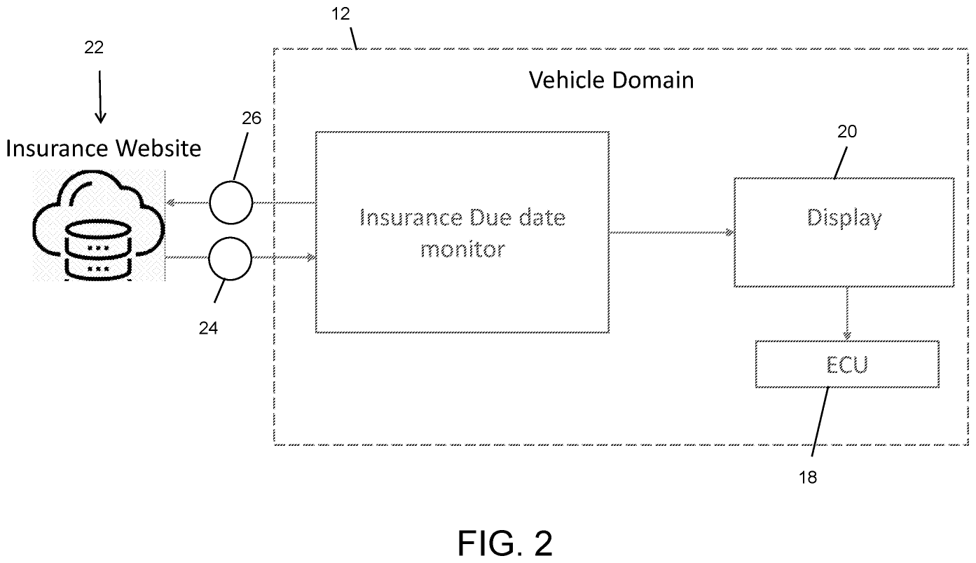

As shown in FIG. 2, the alert system 12 is operable to wirelessly communicate with a remote server 22 via the wireless communication module at the ECU 18. For example, the alert system 12 may transmit signals to the remote server 22 and receive signals from the remote server 22 over a cellular network. The remote server 22 may store (or communicate with a storage device that stores) insurance information 24 related to an insurance policy associated with the vehicle. For example, the remote server 22 may communicate with an insurance data base, such as the website of an insurance provider or a government website.

The driver may initiate or configure the communication between the remote server 22 and the system 12, such as by inputting information identifying the insurance policy associated with the vehicle. For example, the driver may provide information related to an insurance provider and/or a policy number via a human machine interface (HMI), such as the vehicle touch screen display or a mobile device of the driver that is in communication with the system 12. The system 12 may communicate with the remote server 22 to verify the insurance policy and, upon verification of the policy, the system 12 may store policy information in memory at the vehicle for future communications with the remote server 22.

By way of example, the system 12 may be configured to wirelessly communicate with a plurality of remote servers and/or a plurality of websites, each associated with one or more insurance providers, and the system 12 may determine which remote server 22 or website to wirelessly communicate with based on the driver's inputs. That is, the system 12 may identify and establish a connection between the wireless communication module at the ECU 18 and the remote server 22 that stores insurance information related to an insurance policy associated with the vehicle based on inputs received from the driver at the HMI. Based on the driver providing inputs associated with the insurance carrier and the policy for the vehicle, the system 12 wirelessly transmits signals to the remote server corresponding to the insurance carrier to verify existence of the policy. For example, the outgoing signal may include a policy identifier and/or biographical information for the driver. Based on an incoming signal from the remote server 22 that verifies the policy, the system 12 may store in memory the policy information (e.g., the insurance carrier and/or policy identifier) for establishing connection between the vehicle and the remote server at a later time.

Optionally, the system 12 may automatically identify and establish the connection between the vehicle and the remote server 22 to receive or determine insurance information for the vehicle. For example, government regulations may require a vehicle to be insured, and so the remote server 22 may communicate with a government data base that stores information related to vehicle insurance policies based on, for example, a vehicle identification number (VIN). Based on the vehicle's VIN (or other vehicle information stored in memory at the vehicle), the system may request the insurance information 24 from the remote server 22. Furthermore, the system 12 may obtain information from the government database related to the insurance provider holding the policy associated with the vehicle and identify another remote server 22 associated with the insurance provider based on that received information to obtain additional information related to the insurance policy. In other words, the system 12 may communicate with the first remote server (e.g., government database) to obtain insurance policy information associated with the vehicle and, based on the obtained insurance policy information the system 12 may communicate with a second remote server (e.g., the insurance provider) to verify the insurance policy information. Thus, the system 12 may be configured to receive insurance information 24 for the vehicle without input from the driver and may update or track insurance information over the life of the vehicle, such as if the driver changes policies or if ownership of the vehicle is transferred to a new policy holder.

The system 12 may request any suitable insurance information 24 from the remote server 22. For example, the insurance information 24 may include expiration information (e.g., an expiration date or time until expiration of the policy), coverage information (e.g., related to situations or damages or identities of drivers covered by the policy), policy rate information (e.g., deductible and premium costs), and the like.

Based on the received insurance information, the alert system 12 determines existence of a valid insurance policy associated with the vehicle, which may be an insurance policy that is not expired, provides minimum coverage required by local regulations, and that provides coverage for the vehicle when being driven by the current driver. If the system determines a valid insurance policy, the alert system 12 may determine an expiration time (such as a specific day, month, quarter, or year) at which time the insurance policy associated with the vehicle will expire. If the time until expiration is less than a threshold time period (e.g., less than one month or less than two weeks or less than one week), the alert system 12 communicates an alert to the driver of the vehicle to inform the driver that the insurance policy requires renewal within the threshold period of time. For example, the alert system 12 may issue the alert if the insurance policy will expire in less than a month, a week, a day, or any other suitable threshold period of time. The system 12 may generate the alert to the driver in any suitable manner, such as via an audible alert or tone or message played over an audio system of the vehicle, a message or graphical display displayed at a display screen of the vehicle, a message transmitted to a mobile device of the vehicle (e.g., an email or text message or alert through a mobile application associated with the vehicle), and the like.

The alert system 12 may generate progressive alerts based on an approaching expiration time. For example, if the expiration time is within a first threshold period of time (e.g., one month), the alert system 12 may display a message at a display of the vehicle (e.g., gauge cluster or infotainment screen) when the driver enters the vehicle and/or starts the vehicle. If the expiration time is within a second threshold period of time that is less than the first threshold period of time (e.g., one week), the alert system 12 may provide the displayed message and may also transmit a message to display at the mobile device of the driver. And, if the expiration time is within a third threshold period of time that is less than the second threshold period of time and the first threshold period of time (e.g., one day), the alert system 12 may display the message at the vehicle display, transmit the message to the mobile device of the driver, and play an audio signal (e.g., a tone or message) inside the vehicle when the driver enters the vehicle or starts the vehicle. The alert system 12 may provide any suitable alert or message to the driver.

If the alert system 12 determines that the insurance policy associated with the vehicle is invalid (e.g., expired or not providing minimum required coverage or not providing coverage for the current driver of the vehicle), or if the alert system 12 is unable to identify a valid insurance policy, the system may set one or more limits on the operation of the vehicle. For example, the system 12 may limit a maximum speed or acceleration rate of the vehicle, or any suitable performance measure or operability of the powertrain of the vehicle. Thus, when the system determines an invalid insurance policy, the driver is unable to operate the vehicle above a threshold speed or otherwise access the full performance of the vehicle. Therefore, the system 12 may reduce the possibility that the vehicle will be involved in a risky or dangerous situation (e.g., highway driving at a high speed) without being covered by insurance.

Optionally, the system 12 may limit comfort features of the vehicle, such as by limiting operation of a heating, ventilation, and air conditioning (HVAC) system of the vehicle. For example, the alert system 12 may disable the HVAC system or set maximum and minimum settings for climate control of the vehicle to encourage renewal of the insurance policy. For example, the system may limit operation of the HVAC system so that the driver may only adjust the temperature between a maximum temperature and a minimum temperature. Other comfort features, such as heated or cooled seats, radio and audio playback, navigation systems, or remote start, may similarly be limited or disabled when the system determines that no valid insurance policy is associated with the vehicle. For example, the system may limit operation of the radio to only allow AM stations while prohibiting use of FM or satellite radio stations.

The alert system 12 may store the performance or comfort limit in memory of the vehicle, such as at the ECU 18, so that the limit may be applied to operation of the vehicle until the system determines that a valid insurance policy is associated with the vehicle. In other words, the alert system 12, responsive to determining that the insurance policy is expired (or responsive to being unable to determine existence of a valid insurance policy), communicates a signal to one or more systems of the vehicle (such as the HVAC system or powertrain system or infotainment system) and, responsive to the signal from the alert system 12, the vehicle system limits operation of the related vehicle function. The affected vehicle system may be controlled by the same ECU 18 of the alert system 12 or another ECU at the vehicle.

In the illustrated embodiment, the alert system 12 notifies the driver of the limits placed on operation of the vehicle. That is, the alert system 12 displays a message to the driver of the vehicle via the vehicle display 20 when a limit is placed on operation of the vehicle so that the driver is aware of the limit and possible actions the driver can take to remove the limitation. For example, the system may remove the limitation if the driver renews the insurance policy or acknowledges the risk of driving the vehicle without insurance coverage. That is, when the system determines that the insurance policy is not valid and disables or limits functionality of the vehicle, the driver may restore functionality of the vehicle via input (e.g., a selection acknowledging risks of driving the vehicle without insurance) and/or by obtaining a valid policy. The system may automatically determine that there is once again a valid policy associated with the vehicle, such as by episodically communicating with the remote server. Optionally, the alert system 12 disables an input associated with the disabled or limited comfort feature (such as rendering a button associated with the feature inoperable) so that the driver may be aware of the feature's limitations.

Optionally, the alert system 12 may use a driver monitoring system of the vehicle to determine an identity of the current driver of the vehicle and determine whether the identity of the driver corresponds to a person that is covered by the insurance policy associated with the vehicle. If the identity of the driver does not correspond to a person covered by the policy, the system may determine that the policy is invalid for the current driver and display an alert to that driver (and optionally transmit an alert to the covered driver's smart phone) and/or may limit operation of the vehicle. For example, the driver monitoring system may include a driver monitoring camera disposed at the electronics module 14 and viewing a head region of the driver. The ECU 18 may process image data captured by the driver monitoring camera to determine the identity of the driver.

The system 12 may request the insurance information 24 automatically, such as upon vehicle startup, or when prompted by a signal received at the ECU 18. For example, when determining whether the insurance policy is expired or within the threshold period of time from expiration, the system 12 may request the insurance information upon vehicle startup and determine whether to issue an alert to the driver or limit operation of the vehicle. Responsive to receiving the insurance information 24, the system 12 may store the insurance information in memory at the vehicle.

Optionally, the wireless communication module may receive a signal from a remote device requesting some or all of the insurance information 24 and, in response to the received signal, the system 12 may communicate, via the wireless communication module the requested insurance information to the remote device. For example, if involved in a traffic stop with police, a police officer may use a wireless device to transmit a request for proof of insurance. Responsive to receipt of the request from the police officer's device, the system may request insurance information from the remote server (or optionally retrieve insurance information from memory at the vehicle) and communicate the insurance information to the police officer's device. Similarly, a mechanic may use a remote device to request insurance information from the vehicle when completing repairs or maintenance on the vehicle.

In some implementations, systems of the vehicle may determine that the vehicle has been involved in a collision. Responsive to determination that the vehicle has been involved in a collision, the system may communicate a request via the wireless communications module requesting insurance information from any other vehicle that may have been involved in the collision. If another vehicle is equipped with the alert system and receives the communication from the equipped vehicle, and determines that it too has been involved in a collision, the alert systems of the two vehicles may share insurance information with one another. This reduces risks involved with a hit and run (where a driver may collide with another vehicle and flee without sharing insurance information), ensures that insurance information is shared with the owner of a parked vehicle involved in the collision (so that the offending driver's insurance information may be shared without requiring the offending driver seek out and find the owner of the parked vehicle), and reduces the stress of drivers involved in collisions (because they can focus on the safety of themselves and their passengers instead of sharing insurance information). Thus, the system may receive and store insurance information (and/or other vehicle identification information) from other vehicles when involved in a collision or traffic stop.

Optionally, the alert system 12 may communicate to the remote server 22, via the wireless communication module, driving data 26 related to operation of the vehicle, such as sensor data captured by one or more sensors or cameras disposed at the vehicle, or data generated based on driver inputs (such as steering inputs, usage of a turn signal indicator, volume of the vehicle sound system, and the like). For example, the alert system 12 may communicate driving data 26 related to a driving condition of the vehicle, such as speed data related to the rates of travel of the vehicle or image data representative of the road conditions. Driving data 26 may be transmitted to the remote server 22 to, for example, aid the insurance provider in setting rates for the vehicle, determining if the insurance policy has been violated, or in providing evidence for an insurance claim. Optionally, the system 12 may process the captured sensor data at the ECU 18 prior to transmitting the driving data 26 to the remote server, or the system 12 may transmit raw sensor data for processing on the remote server.

Therefore, the alert system 12 receives the insurance status of the vehicle through the internet. The system 12 may subscribe to the insurance entity to monitor the renewal date. In other words, the system 12 may regularly (such as upon vehicle startup) request and receive the insurance information from the remote server. The system notifies the driver, such as with an optical/text warning, if the insurance renewal is due in less than a threshold number of days. Subsequent text warnings or acoustic/chime warnings may be provided during vehicle startup or shut down or while the vehicle is running as the renewal due date approaches. If the insurance policy expires, the operation of the vehicle may be limited. For example, the maximum speed of the vehicle may be set to a threshold speed and comfort features may disabled at the human machine interface (HMI). When operation of the vehicle is limited or restricted, the driver may be less likely to be involved in a collision or other situation that would otherwise be covered by vehicle insurance. Thus, limiting operation reduces potential of legal liability arising between the vehicle owner and/or driver and third parties that result in loss of time and money and increased stress. The system is also beneficial for insurance providers as it reduces the occurrence of late payment and lapsed policies.

In some examples, the alert system 12 may communicate with the remote server to ensure compliance with other mandates or policies associated with the vehicle, such as to ensure that registration for the vehicle is current, that required maintenance has been performed on the vehicle, and the like. Thus, the alert system generates the alert to the driver before the due date or expiration date to allow the driver the opportunity to remain in compliance with the policy or regulation associated with the vehicle. The system may degrade features, like limiting vehicle speed or a comfort feature, after the due date, such as to avoid risks associated with expiration or non-compliance.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or pixels arranged in rows and columns. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The system may also communicate with other systems, such as via a vehicle-to-vehicle communication system or a vehicle-to-infrastructure communication system or the like. Such car2car or vehicle to vehicle (V2V) and vehicle-to-infrastructure (car2X or V2X or V2I or a 4G or 5G broadband cellular network) technology provides for communication between vehicles and/or infrastructure based on information provided by one or more vehicles and/or information provided by a remote server or the like. Such vehicle communication systems may utilize aspects of the systems described in U.S. Pat. Nos. 10,819,943; 9,555,736; 6,690,268; 6,693,517 and/or 7,580,795, and/or U.S. Publication Nos. US-2014-0375476; US-2014-0218529; US-2013-0222592; US-2012-0218412; US-2012-0062743; US-2015-0251599; US-2015-0158499; US-2015-0124096; US-2015-0352953; US-2016-0036917 and/or US-2016-0210853, which are hereby incorporated herein by reference in their entireties.

The system may utilize aspects of driver monitoring systems and/or head and face direction and position tracking systems and/or eye tracking systems and/or gesture recognition systems. Such head and face direction and/or position tracking systems and/or eye tracking systems and/or gesture recognition systems may utilize aspects of the systems described in U.S. Pat. Nos. 11,518,401; 10,958,830; 10,065,574; 10,017,114; 9,405,120 and/or 7,914,187, and/or U.S. Publication Nos. US-2022-0377219; US-2022-0254132; US-2022-0242438; US-2021-0323473; US-2021-0291739; US-2020-0320320; US-2020-0202151; US-2020-0143560; US-2019-0210615; US-2018-0231976; US-2018-0222414; US-2017-0274906; US-2017-0217367; US-2016-0209647; US-2016-0137126; US-2015-0352953; US-2015-0296135; US-2015-0294169; US-2015-0232030; US-2015-0092042; US-2015-0022664; US-2015-0015710; US-2015-0009010 and/or US-2014-0336876, and/or International Publication Nos. WO 2023/034956; WO 2022/241423 and/or WO 2022/187805, and/or PCT Application No. PCT/US2023/021799, filed May 11, 2023 (Attorney Docket DON01 FP4810WO), which are all hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular alert system, the vehicular alert system comprising:
an electronic control unit (ECU) disposed at a vehicle equipped with the vehicular alert system, wherein the ECU comprises electronic circuitry and associated software;
wherein the vehicular alert system is in wireless communication with a remote server that is remote from the vehicle;
wherein the vehicular alert system receives a first wireless communication from the remote server, and wherein the first wireless communication is pertaining to an insurance policy associated with the vehicle; and
wherein the vehicular alert system, based on the first wireless communication, and responsive to determination that the insurance policy will expire in less than a threshold period of time, generates an alert for a driver of the vehicle.

2. The vehicular alert system of claim 1, wherein the vehicular alert system, responsive to determination that the insurance policy has expired, limits operation of a system of the vehicle.

3. The vehicular alert system of claim 2, wherein the system of the vehicle comprises a powertrain system of the vehicle.

4. The vehicular alert system of claim 3, wherein, based on the vehicular alert system limiting operation of the powertrain system of the vehicle, the vehicle is unable to travel at a speed greater than a threshold speed.

5. The vehicular alert system of claim 2, wherein the system of the vehicle comprises a heating, ventilation, and air conditioning (HVAC) system of the vehicle.

6. The vehicular alert system of claim 5, wherein the vehicular alert system disables operation of the HVAC system.

7. The vehicular alert system of claim 1, wherein the alert comprises a graphical display displayed at a display device of the vehicle.

8. The vehicular alert system of claim 1, wherein the alert comprises a second wireless communication transmitted from the vehicle to a mobile device of the driver.

9. The vehicular alert system of claim 1, wherein the vehicular alert system wirelessly communicates a second wireless communication to the remote server, and wherein the second wireless communication comprises sensor data captured by one or more sensors disposed at the vehicle and representative of a driving condition of the vehicle.

10. The vehicular alert system of claim 1, wherein the vehicular alert system wirelessly communicates a second wireless communication to the remote server, and wherein the second wireless communication comprises a request for information pertaining to the insurance policy associated with the vehicle.

11. The vehicular alert system of claim 10, wherein the vehicular alert system wirelessly communicates the second wireless communication responsive to receiving an input from the driver, and wherein the input comprises information pertaining to the insurance policy associated with the vehicle.

12. The vehicular alert system of claim 10, wherein the vehicular alert system wirelessly communicates the second wireless communication automatically upon vehicle startup, and wherein the second wireless communication comprises vehicle identification information.

13. The vehicular alert system of claim 1, wherein the vehicular alert system wirelessly communicates a second wireless communication to a device remote from the vehicle, and wherein the second wireless communication comprises information pertaining to the insurance policy associated with the vehicle.

14. The vehicular alert system of claim 13, wherein the device comprises another vehicle, and wherein the vehicular alert system wirelessly communicates the second wireless communication to the other vehicle responsive to determination that the vehicle has collided with the other vehicle.

15. The vehicular alert system of claim 13, wherein the vehicular alert system wirelessly communicates the second wireless communication to the device responsive to a request received from the device for the information pertaining to the insurance policy associated with the vehicle.

16. The vehicular alert system of claim 1, wherein the vehicular alert system, responsive to receiving the first wireless communication at the ECU, determines an expiration date of the insurance policy.

17. A vehicular alert system, the vehicular alert system comprising:
an electronic control unit (ECU) disposed at a vehicle equipped with the vehicular alert system, wherein the ECU comprises electronic circuitry and associated software;
wherein the vehicular alert system is in wireless communication with a remote server that is remote from the vehicle;
wherein the vehicular alert system wirelessly communicates a first wireless communication to the remote server, and wherein the first wireless communication comprises a request for information pertaining to an insurance policy associated with the vehicle;
wherein, based on the first wireless communication, the vehicular alert system receives a second wireless communication from the remote server, and wherein the second wireless communication comprises the information pertaining to the insurance policy associated with the vehicle;
wherein the vehicular alert system, responsive to receiving the second wireless communication at the ECU, determines an expiration date of the insurance policy; and
wherein the vehicular alert system, responsive to determination that the insurance policy will expire in less than a threshold period of time, generates an alert for a driver of the vehicle.

18. The vehicular alert system of claim 17, wherein the vehicular alert system, responsive to determination that the insurance policy has expired, limits operation of a system of the vehicle.

19. The vehicular alert system of claim 18, wherein the system of the vehicle comprises one selected from the group consisting of (i) a powertrain system of the vehicle and (ii) a heating, ventilation, and air conditioning (HVAC) system of the vehicle.

20. The vehicular alert system of claim 17, wherein the alert comprises one selected from the group consisting of (i) a graphical display displayed at a display device of the vehicle and (ii) a third wireless communication transmitted from the vehicle to a mobile device of the driver.

21. A vehicular alert system, the vehicular alert system comprising:
an electronic control unit (ECU) disposed at a vehicle equipped with the vehicular alert system, wherein the ECU comprises electronic circuitry and associated software;
wherein the vehicular alert system is in wireless communication with a remote server that is remote from the vehicle;
wherein the vehicular alert system receives a first wireless communication from the remote server, and wherein the first wireless communication is pertaining to an insurance policy associated with the vehicle;
wherein the vehicular alert system, based on the first wireless communication, and responsive to determination that the insurance policy will expire in less than a threshold period of time, generates an alert for a driver of the vehicle;
wherein the alert comprises one selected from the group consisting of (i) a graphical display displayed at a display device of the vehicle and (ii) a second wireless communication transmitted from the vehicle to a mobile device of the driver; and
wherein the vehicular alert system, responsive to determination that the insurance policy has expired, limits operation of a system of the vehicle.

22. The vehicular alert system of claim 21, wherein the system of the vehicle comprises a powertrain system of the vehicle.

23. The vehicular alert system of claim 22, wherein, based on the vehicular alert system limiting operation of the powertrain system of the vehicle, the vehicle is unable to travel at a speed greater than a threshold speed.

24. The vehicular alert system of claim 21, wherein the system of the vehicle comprises a heating, ventilation, and air conditioning (HVAC) system of the vehicle.

25. The vehicular alert system of claim 24, wherein the vehicular alert system disables operation of the HVAC system.
